(19) United States
(12) Patent Application Publication
(10) Pub. No.: US 2009/0007432 A1
(43) Pub. Date: Jan. 8, 2009

(54) Holder for razor head

(75) Inventor: Wan-Shun Chou, Taipei (TW)

Correspondence Address: BIRCH STEWART KOLASCH & BIRCH, PO BOX 747, FALLS CHURCH, VA, 22040-0747, US

(73) Assignee: I-CHIUN PRECISION INDUSTRY CO., LTD.

(21) Appl. No.: 11/979,059

(22) Filed: Oct. 30, 2007

(30) Foreign Application Priority Data
Jul. 6, 2007 (TW) 096124711

(51) Int. Cl. B26B 21/00

(52) U.S. Cl. 30/32

(57) ABSTRACT

The invention discloses a holder for a razor head. The holder includes a mounting base thereon defining a first direction and a second direction perpendicular to the first direction, a holding member which includes a first holding part and a second holding part for holding the razor head, and an actuating member. The first holding part and the second holding part are engaged to the mounting base and capable of sliding along the first direction. The actuating member is engaged to the mounting base and capable of sliding along the second direction. When the actuating member slides along the positive of the second direction, the first holding part and the second holding part slide toward each other along the first direction; when the actuating member slides along the negative of the second direction, the first holding part and the second holding part slide oppositely along the first direction.

### BACKGROUND OF THE INVENTION

1. Field of the Invention

The invention relates to a holder for a razor head and particularly to a holder for horizontally holding a razor head.

2. Description of the Prior Art

Generally, a separable razor head can be separated into a razor handle and a razor head. The razor handle has a holder for holding the razor head. Traditionally, the holder utilizes a shear mechanism or a multi-bar mechanism. However, in prior art, the horizontal hold had not been realized yet; besides, too many linkage mechanisms were involved. Since the holder with an un-horizontal hold easily interferes with the object being held (alternatively, a razor head), it causes the wear of the object and further lowers the holding capability of the holder. Moreover, too many linkage mechanisms raise the complexity of producing a product, and further lower the yield rate.

Please refer to FIG. 1A. FIG. 1A is a schematic diagram illustrating a razor 1 in prior art. The razor 1 includes a razor handle 12 and a razor head 14. A holder 16 (as the dotted line shown in FIG. 1A) is disposed on the razor handle 12. Please refer to FIG. 1B. FIG. 1B is a schematic diagram illustrating the holder 16. The dotted lines in FIG. 1B shows another state of the holder 16. An arrow in FIG. 1B shows an actuation direction of the holder 16. As shown in FIG. 1B, a moving direction of a first holding part 162 and a second holding part 164 of the holder 16 is not horizontal and is far from each other. Therefore, there must be a sufficient distance between the razor head 14 and the holder 16 to prevent from interfering. As a result, the holding capability is lowered. However, if the holding capability is needed to be maintained, the razor head 14 will interfere with the holder 16. Consequently, the holding capability is lowered as well.

Please refer to FIG. 1C. FIG. 1C is a schematic diagram illustrating another holder 16′ in prior art. Another state of the holder 16′ is shown as the dotted lines in FIG. 1C. As shown in FIG. 1C, the moving directions of the first holding part 162′ and the second holding part 164′ of the holder 16′ are not horizontal, and the mechanism of the holder 16′ in FIG. 1C is more complex than that of the holder 16 in FIG. 1B.

Therefore, the holder 16′ still has disadvantages of the holder 16. Additionally, the holder 16′ is composed of more components, such that the product is not easily manufactured, and the yield rate is not easily raised.

Accordingly, even though a more complex linkage mechanism had been utilized in prior art, a horizontal movement had not been realized yet. And, it resulted in that there should be a sufficient distance between the razor head and the holder to prevent from interfering. As a result, the holding capability of the holder became lower. Therefore, a holder of the invention for a razor capable of horizontally moving is provided to solve the aforesaid problems.

### SUMMARY OF THE INVENTION

A scope of the invention is to provide a holder for horizontally holding a razor head.

The holder of the invention is used for holding a razor head. The holder includes a mounting base, a holding member, and an actuating member. The mounting base defines a first direction and a second direction perpendicular to the first direction. The holding member includes a first holding part and a second holding part for holding the razor head, and the first holding part and the second holding part are engaged to the mounting base and capable of sliding along the first direction. The actuating member is engaged to the mounting base and capable of sliding along the second direction. Wherein, when the actuating member slides along the positive of the second direction, the first holding part and the second holding part slide toward each other along the first direction. When the actuating member slides along the negative of the second direction, the first holding part and the second holding part slide oppositely along the first direction.

According to the invention, the actuating member is engaged to the first holding part and the second holding part. In an embodiment, the first holding part includes a first surface, the actuating member includes a second surface, and the second surface slidably contacts the first surface. The first surface and the second surface are inclined surfaces, and the first surface is substantially parallel to the second surface. Additionally, according to the invention, the mounting base includes a first track and a second track. The first holding part is engaged to the first track and capable of sliding along the first track, and the second holding part is engaged to the second track and capable of sliding along the second track.

In an embodiment, when the actuating member actuates the first holding part and the second holding part, the holder of the invention further includes a first elastic member in order to keep the actuating member being engaged to the first holding part and the second holding part. The first elastic member includes a first end engaged to the first holding part and a second end engaged to the second holding part. Or, the holder further includes a second elastic member and a third elastic member. The second elastic member includes a third end engaged to the mounting base and a fourth end engaged to the first holding part. The third elastic member includes a fifth end engaged to the mounting base and a sixth end engaged to the second holding part.

In an embodiment, the holder of the invention further includes a fourth elastic member. The fourth elastic member includes a seventh end engaged to the actuating member and an eighth end engaged to the mounting base. Additionally, the holder further includes a support member and a fifth elastic member. The fifth elastic member includes a ninth end engaged to the support member and a tenth end engaged to the mounting base. When the first holding part and the second holding part hold the razor head together, the support member urges against the razor head.

In the former embodiment, the actuating member and the support member are respectively engaged to the mounting base by an elastic member. In a practical design, the actuating member and the support member can collectively utilize the same elastic member. For example, in an embodiment, the holder of the invention further includes a support member and a sixth elastic member. The support member includes a support part and a slide part slidably and limitedly engaged to the mounting base. The sixth elastic member includes an eleventh end engaged to the slide part and a twelfth end engaged to the actuating member. When the first holding part and the second holding part hold the razor head together, the support part of the support member urges against the razor head.

Therefore, the holder of the invention for a razor head can realize a horizontal hold and utilize an elastic member to keep a hold position. Additionally, the holder of the invention for a razor head prevents from utilizing a linkage mechanism, simplifies a hold mechanism, raises the yield rate of the product, lowers the cost of manufacture, and solves the aforesaid disadvantages of prior art.

The advantage and spirit of the invention may be understood by the following recitations together with the appended drawings.

### BRIEF DESCRIPTION OF THE APPENDED DRAWINGS

FIG. 1A is a schematic diagram illustrating a razor in prior art.

FIG. 1B is a schematic diagram illustrating a holder in prior art.

FIG. 1C is a schematic diagram illustrating another holder in prior art.

FIG. 2A is an explosive diagram illustrating a holder for a razor head according to a preferred embodiment.

FIG. 2B is a stereoscopic diagram illustrating anther view angle of an actuating member.

FIG. 3A is a schematic diagram illustrating an actuation relation between an actuating member and a first holder and a second holder when a holder is at a first state.

FIG. 3B is a schematic diagram illustrating an actuation relation between an actuating member and a first holder and a second holder when a holder is at a second state.

FIG. 3C is a schematic diagram illustrating an actuation relation between an actuating member and a support member when a holder is at a first state.

FIG. 3D is a schematic diagram illustrating an actuation relation between an actuating member and a support member when a holder is at a second state.

FIG. 3E is a schematic diagram illustrating an actuation relation between an actuating member and a support member when a holder is at a third state.

FIG. 4 is a schematic diagram illustrating a razor applied to the holder of the invention.

FIG. 5A is another schematic diagram illustrating an actuation relation between an actuating member and a first holding part and a second holding part when a holder is at the first state.

FIG. 5B is an another schematic diagram illustrating an actuation relation between an actuating member and a first holding part and a second holding part when a holder is at the second state

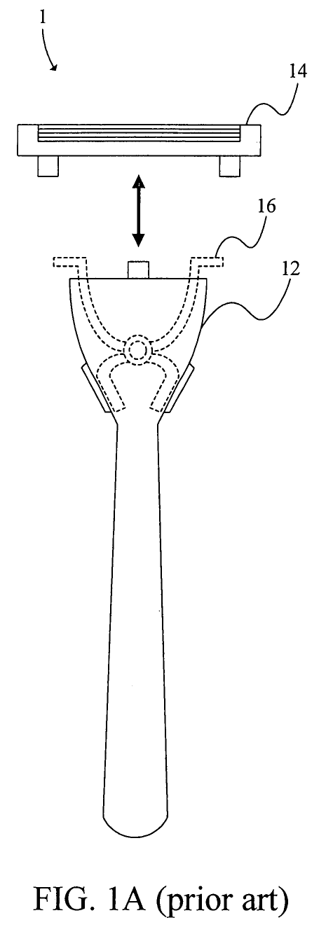

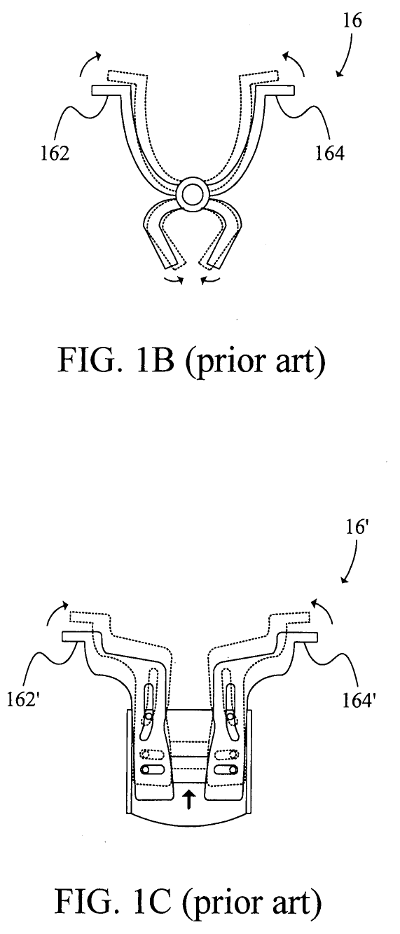

### DETAILED DESCRIPTION OF THE INVENTION

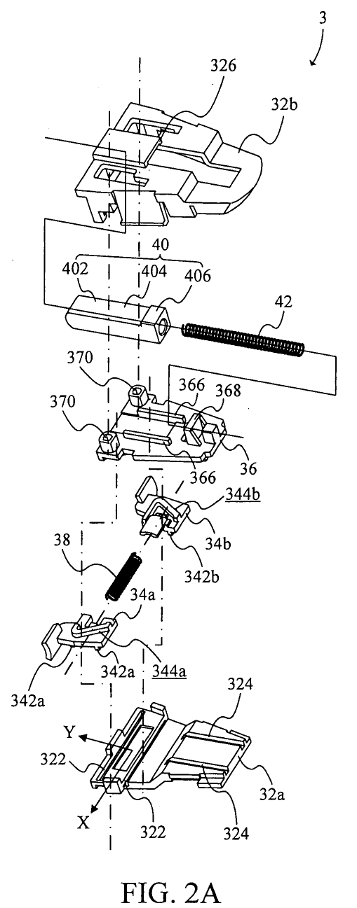

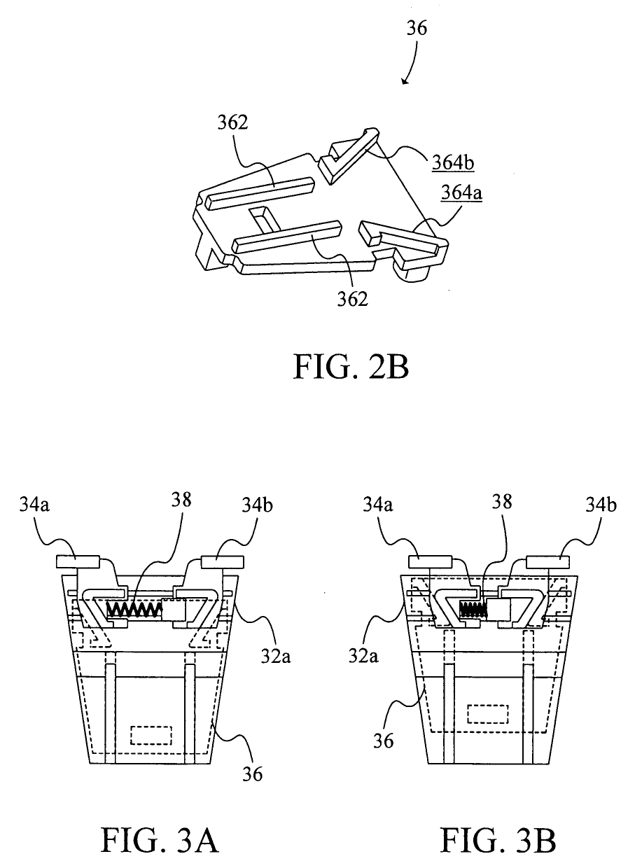

Please refer to FIG. 2A. FIG. 2A is an explosive diagram illustrating a holder 3 for a razor head according to a preferred embodiment. The holder 3 includes a mounting base composed of a base 32a and an up-cover 32b, a holding member composed of a first holding part 34a and a second holding part 34b, an actuating member 36, a first ring 38, a support member 40, and a second ring 42. The base 32a thereon defines a horizontal direction X and a perpendicular direction Y. Two tracks 322 are formed on the base 32a along the horizontal direction X, and oppositely, two protrusions 342a are formed on the first holding part 34a, which limitedly slide along the tracks 322. Similarly, two protrusions 342b are formed on the second holding part 34b, which limitedly slide along the tracks 322. It should be noticed that the number of the protrusions 342a formed on the first holding part is not necessarily equal to the number of the tracks 322. And, the number of the tracks 322 is not limited to two. The aforesaid description can be applied to the second holding part 34b.

Please refer to FIG. 2B. FIG. 2B is a stereoscopic diagram illustrating anther view angle of the actuating member 36. The actuating member 36 includes two protrusions 362, and two tracks 324 are formed on the base 32a along the perpendicular direction Y. The protrusions 362 of the actuating member 36 limitedly slide along the tracks 324 of the base 32a. An end of the first ring 38 is engaged to the first holding part 34a, and another end is engaged to the second holding part 34b. When the first holding part 34a and the second holding part 34b slide toward each other along the parallel direction X, the first ring 38 returns the first holding part 34a and the second holding part 34b back to the original positions. The first holding part 34a has protrusions for providing a first slide surface 344a and similarly, the second holding part 34b has protrusions for providing anther first slide surface 344b. Oppositely, the actuating member 36 has protrusions for providing two second slide surfaces 364a and 364b to slidably contact the first surfaces 344a and 344b respectively.

The support member 40 includes a support part 402 and a slide part 404. The slide part 404 is slidably and limitedly engaged to the up-cover 32b. According the preferred embodiment, protrusions 366 are formed on the actuating member 36, the slide part 404 slides between the protrusions 366 to raise the slide stability of itself. But the invention is not limited to this. An end of the second ring 42 is engaged to the slide part 404, and anther end is engaged to a stop part 368 of the actuating member 36.

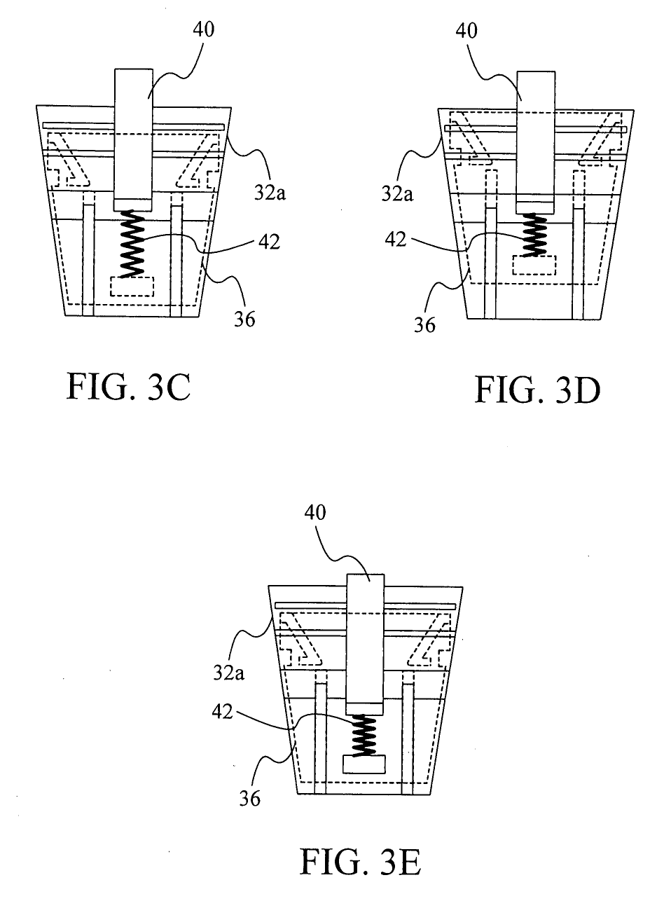

Please refer to FIG. 3A and 3B. FIG. 3A is a schematic diagram illustrating an actuation relation between the actuating member 36 and the first holder 34a and the second holder 34b when the holder 3 is at a first state. FIG. 3B is a schematic diagram illustrating an actuation relation between the actuating member 36 and the first holder 34a and the second holder 34b when the holder 3 is at a second state. Wherein, the up-cover 32b, the support member 40, and the second ring 42 are not shown in the FIG. 3A and 3B, the first ring 38 is shown as a thick line, and the actuating member 36 is shown as a dotted line. The first state means the holder 3 is in a condition that the actuating member 36 is not driven by a user. The second state means the holder 3 is in a condition that the actuating member 36 is driven by a user to move along the positive of the perpendicular direction Y, such that the first holding part 34a and the second holding part 34b move toward each other along the horizontal direction X, and the first ring 38 is in a condition of being pressed by the first holding part 34a and the second holding part 34b.

As shown in FIG. 3A and 3B (detailed illustrations are shown in FIG. 2A and 2B), the actuating member 36 enables the first holding part 34a and the second holding part 34b to move toward each other by the sliding contact between the second slide surfaces 364a and 364b and the first slide surfaces 344a and 344b, and a geometry limit such as the tracks 322. Since the first ring 38 is pressed by the first holding part 34a and the second holding part 34b to generate a force for returning the first holding part 34a and the second holding part 34b to the original positions, the first slide surfaces 344a and 344b urge against the second slide surfaces 364a and 364b to effectively control the actuation positions of the first holding part 34a and the second holding part 34b. Therefore, when the actuating member 36 moves along the opposite of the perpendicular direction Y, the first holding part 34a and the second holding part 34b move oppositely along the horizontal direction X and then return to the original positions.

Please refer to FIG. 3C and 3D. FIG. 3C is a schematic diagram illustrating an actuation relation between the actuating member 36 and the support member 40 when the holder 3 is at a first state. FIG. 3D is a schematic diagram illustrating an actuation relation between the actuating member 36 and the support member 40 when the holder 3 is at a second state. Herein, the up-cover 32b, the first holding part 34a, the second holding part 34b, and the first ring 38 are not shown in FIG. 3C and 3D; the second ring 42 is shown as a thick line; and the actuating member 36 is shown as a dotted line. Please refer to FIG. 2A. The support member 42 has a protrusion part 406 which can be stopped by the stop part 326 of the up-cover 32b. Alternatively, the actuating member 36 is indirectly engaged to the up-cover 32b by the second ring 42. Therefore, when the actuating member 36 is at a second state, the second ring 42 is pressed to generate a force for returning the actuating member 36 to the original position at the first state. Further, the actuating member 36 can return back to the original position at the first state without being pressed by a force of a user.

Please refer to FIG. 3C and 3E. FIG. 3E is a schematic diagram illustrating an actuation relation between the actuating member 36 and the support member 40 when the holder 3 is at a third state. Herein, the third state means the support member 40 is at a state as being pressed. Because the actuating member 36 is disposed in the mounting base composed of the base 32a and the up-cover 32b; in other words, the actuating member 36 can be stopped by the mounting base, the support member 40 is indirectly engaged to the mounting base by the second ring 42. At the third state, the second ring 42 is pressed to generate a force for returning the support member 40 to the original position at the first state. Further, when an external force pressing the support member 40 does not exist, the support member 40 automatically returns back to the original position at the first state.

As shown in FIG. 3C to 3E, the actuating member 36 returns back to the original position is independent of the support member 40. Namely, instead of the second ring 42, another ring is directly engaged to the actuating member 36 and the up-cover 32b. An end of the ring is engaged to the actuating member 36, and another end is engaged to the up-cover 32b. At the same time, when the actuating member 36 is at a second state, the ring also is pressed to generate a fore for returning the actuating member 36 back to the original position at the first state. Similarly, the support member 40 returns back to the original position is independent of the actuating member 36. Namely, instead of the second ring, another ring is directly engaged to the support member 40 and the up-cover 32b. An end of the ring is engaged to the support member 40, and another end is engaged to the up-cover 32b. At the third state, the ring is pressed to generate a force for returning the support member 40 back to the original position at the first state.

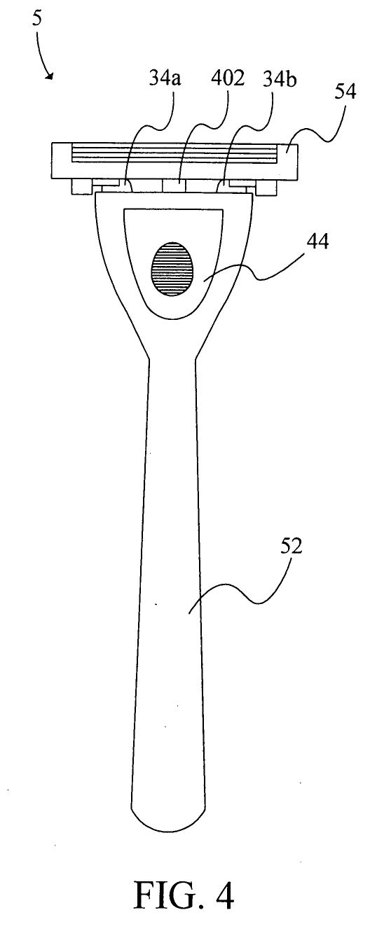

It should be notice that the holder 3 of the invention can be configured on the razor handle 52. Please refer to FIG. 4. FIG. 4 is a schematic diagram illustrating a razor 5 applied with the holder 3 of the invention. When the razor head 54 is engaged to the razor handle 52, the first holding part 34a and the second holding part 34b hold the razor head 54 together, and the support part 402 of the support member 40 urges against the razor head 54. Additionally, a cover 44 engaged to the actuating member 36 can be added for moving the actuating member 36. For example, the cover 44 can be engaged to the fixing hole 370 (as shown in FIG. 2A) of the actuating member 36.

It should be noticed that, according to the preferred embodiment, the first slide surfaces 344a and 344b and the second slide surfaces 364a and 364b are inclined surfaces, and the first slide surfaces 344a and 344b are respectively parallel to the second slide surfaces 364a and 364b. However, the invention is not limited to this. For example, the first slide surfaces 344a and 344b and the second slide surfaces 364a and 364b are curved surfaces. Or, the first slide surfaces 344a and 344b are cylinder surfaces, and the second slide surface 364a and 364b can be curved surfaces or flat surfaces, and vice versa. Certainly, the first slide surfaces 344a and 344b are not limited to the same type; for example, one is a curved surface, and another is a cylinder surface.

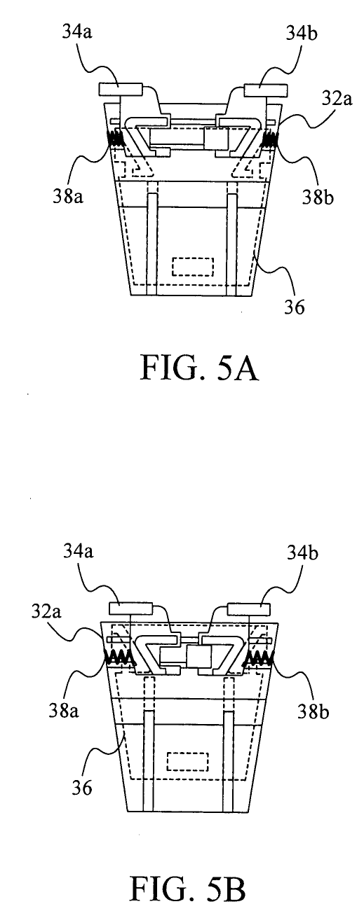

Additionally, the first ring 38 can not be configured between the first holding part 34a and the second holding part 34b; instead, the rings 38a and 38b are used to connect the base 32a or the up-cover 32b respectively. For example, an end of the ring 38a is fixed at the first holding part 34a, and another end is fixed at the base 32a or the up-cover 32b; similarly, an end of the ring 38b is fixed at the second holding part 34b, and another end is fixed at the base 32a or the up-cover 32b. Please refer to FIG. 5A and 5B, FIG. 5A is an another schematic diagram illustrating an actuation relation between the actuating member 36 and the first holding part 34a and the second holding part 34b when the holder 3 is at the first state. FIG. 5B is an another schematic diagram illustrating an actuation relation between the actuating member 36 and the first holding part 34a and the second holding part 34b when the holder 3 is at the second state. Herein, the up-cover 32b, the support member 40, and the second ring 42 are not shown in the FIG. 5A and 5B; the ring 38a and 38b are shown as thick lines; and the actuating member 36 is shown as a dotted line. As shown in FIG. 5B, when the first holding part 34a and the second holding part 34b are at the second state, the rings 38a and 38b are pulled to generate a force for returning the first holding part 34a and the second holding part 34b back to the original positions at the first state. Although the rings 38a and 38b are pulled to generate a returning force, the mechanism and function are the same as those of the first ring 38. It should be noticed that the rings 38a and 38b can be configured between the first holding part 34a and the second holding part 34b. At the same time, the former restoring force is generated by pressing the rings 38a and 38b.

Additionally, according to the preferred embodiment, the first slide surface 344a and 344b are on the second slide surface 364a and 364b, and collaborate with the first ring 38 or the rings 38a and 38b to keep the first slide surfaces 344a and 344b slidably contacting the second slide surface. But the invention is not limited to this. Namely, the second slide surfaces 364a and 364b can be configured between the first slide surfaces 344a and 344b, and collaborate with the disposition of the ring to keep the first slide surfaces 344a and 344b contacting the second slide surfaces 364a and 364b. The variation of the embodiment is well-known in prior art, so it will not be described herein.

Accordingly, the holder of the invention for the razor head can realize a horizontal hold and utilizes elastic members such as rings to keep a holding position. Additionally, the holder of the invention for the razor head prevents from utilizing a linkage mechanism to simplify the hold mechanism, such that the yield rate of the product is raised; the cost of the production is lowered; and the disadvantages of prior art is overcame.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A holder for holding a razor head, the holder comprising:
a mounting base defining a first direction and a second direction perpendicular to the first direction;
a holding member comprising a first holding part and a second holding part for holding the razor head, the first holding part and the second holding part being engaged to the mounting base and capable of sliding along the first direction; and
an actuating member engaged to the mounting base and capable of sliding along the second direction;
wherein when the actuating member slides along a positive of the second direction, the first holding part and the second holding part slide toward each other along the first direction, and when the actuating member slides along a negative of the second direction, the first holding part and the second holding part slide oppositely along the first direction.

2. The holder of claim 1, wherein the actuating member is engaged to the first holding part and the second holding part.

3. The holder of claim 2, wherein the first holding part comprises a first surface, the actuating part comprises a second surface, and the second surface slidably contacts the first surface.

4. The holder of claim 3, wherein the first surface and the second surface are inclined surfaces and the first surface is substantially parallel to the second surface.

5. The holder of claim 1, wherein the mounting base comprises a first track and a second track, the first holding part is engaged to the first track and capable of sliding along the first track and the second holding part is engaged to the second track and capable of sliding along the second track.

6. The holder of claim 1, further comprising a first elastic member, the first elastic member comprising a first end engaged to the first holding part and a second end engaged to the second holding part.

7. The holder of claim 1, further comprising a second elastic member and a third elastic member, the second elastic member comprising a third end engaged to the mounting base and a fourth end engaged to the first holding part, the third elastic member comprising a fifth end engaged to the mounting base and a sixth end engaged to the second holding part.

8. The holder of claim 1, further comprising a fourth elastic member, the fourth elastic member comprising a seventh end engaged to the actuating member and an end engaged to the mounting base.

9. The holder of claim 1, further comprising a support member and a fifth elastic member, the fifth elastic member comprising a ninth end engaged to the support member and a tenth end engaged to the mounting base, wherein when the first holding part and the second holding part hold the razor head together, the support member urges against the razor head.

10. The holder of claim 1, further comprising a support member and a sixth elastic member, the support member comprising a support part and a slide part, the slide part being slidably and limitedly engaged to the mounting base, the sixth elastic member comprising a eleventh end engaged to the slide part and a twelfth end engaged to the actuating member, wherein when the first holding part and the second holding part hold the razor head together, the support part of the support member urges against the razor head.
